(19) United States
(12) Patent Application Publication
(10) Pub. No.: US 2010/0084019 A1
(43) Pub. Date: Apr. 8, 2010

(54) CENTRAL SPOOL VALVE

(75) Inventor: Steven Burke, Fairhaven, MI (US)

Correspondence Address: FITZPATRICK CELLA HARPER & SCINTO, 1290 Avenue of the Americas, NEW YORK, NY, 10104-3800, US

(73) Assignee: SCHAEFFLER KG, Herzogenaurach (DE)

(21) Appl. No.: 12/552,815

(22) Filed: Sep. 2, 2009

Related U.S. Application Data
(60) Provisional application No. 61/103,755, filed on Oct. 8, 2008.

(51) Int. Cl. F15D 1/00; F01L 3/10

(52) U.S. Cl. 137/1; 251/337

(57) ABSTRACT

A spool valve for a camshaft phasing system for an internal combustion engine. The spool valve includes a housing, a check valve, a retention clip, a spring and a hollow spool. The spring and hollow spool are disposed in a bore of the housing. The spring is disposed at least partly in a bore or retention pocket within the hollow spool, and biases between that element and an opposite inner surface of the housing facing the spool bore or retention pocket. The spool valve enables compact operation of a cam phasing system by selectively aligning oil pathways into and out of a camshaft phaser.

This application claims the benefit of provisional U.S. Application No. 61/103,755, filed Oct. 8, 2008, which is hereby incorporated by reference, as if set forth fully herein.

### TECHNICAL FIELD

The invention relates to the field of variable cam timing and more particularly, relates to a spool valve that is used to control a camshaft phaser to vary the timing of a camshaft of an internal combustion engine.

### RELATED ART

U.S. Pat. No. 7,000,580, entitled “Control Valves with Integrated Check Valves”, by Franklin R. Smith et al., and issued on Feb. 21, 2006, generally shows a construction of a spool valve used in a camshaft phasing system with an integrated check valve. U.S. Pat. No. 7,000,580 is incorporated by reference herein in its entirety, as if set forth fully herein.

Camshaft phasers are generally known in two forms, a piston-type phaser with an axially displaceable piston and a vane-type phaser with vanes that can be acted upon and pivoted in the circumferential direction. With either type, the camshaft phaser is fixedly mounted on the end of a camshaft. An example mounting may be performed as disclosed in U.S. Pat. No. 6,363,896, entitled “Camshaft Adjuster for Internal Combustion Engines”, by Wolfgang Speier, issued on Apr. 2, 2002, by the clamping screw forming the element of the camshaft phaser that effects centering relative to the camshaft. U.S. Pat. No. 6,363,896 is incorporated by reference herein in its entirety, as if set forth fully herein.

In order to operate either of these types of phasers it is necessary to selectively supply hydraulic fluid to ports in order to initiate movement. The vane-type phaser, in particular, requires supply of hydraulic fluid, normally engine oil, to opposing chambers in the phaser in order to shift the vane within the phaser circumferentially and thus selectively phase cam timing. To accomplish this, spool valves are utilized, either external to the camshaft phaser or, as here, integrated in the phaser.

Spool valves accomplish the task of supplying and purging hydraulic fluid from the required cavities of the camshaft phaser. An example spool valve known in the art may comprise a housing, a plurality of check valves to prevent oil purging, a perforated hollow spool, a spring, and various ports bringing oil to the valve and carrying oil away, as needed. An external force, often supplied by a magnet mounted on the end of the spool valve, moves the spool fore and aft. As the spool is displaced relative to the housing, annular spaces align with holes in the housing to allow oil egress or ingress.

### SUMMARY OF THE INVENTION

As with many components in the modern internal combustion engine and automobile, it can be useful to reduce weight and size of spool valves, along with a camshaft phaser, in general.

An example aspect of the invention comprises a spool valve for a camshaft phaser, wherein a spring retention pocket is formed in the spool itself, and is used in place of a spring retention recess in the spool valve housings of known devices, providing a uniformly flat surface upon which the spring makes contact in exerting a force to return the spool to starting position. In one example embodiment of the invention, the assembly comprises a housing, a check valve, a hollow spool within the housing, and a spring inserted into a spring retention pocket within the spool.

According to one example embodiment of the invention, the spool valve also comprises a spool with a reduced inner diameter (ID), requiring a smaller transition from the internal ID to the spring retention pocket.

A further example aspect of the invention may utilize a chamfered end of the spool at the insertion point of the spring into the spring retention pocket. In addition, a further example embodiment may utilize a tapered spring at the contact surface with the spool valve housing.

A method for operating the spool valve, as described above, also is provided.

### DESCRIPTION OF DRAWINGS

The above mentioned and other features and advantages of this invention, and the manner of attaining them, will become apparent and be better understood by reference to the following description of at least one example embodiment of the invention in conjunction with the accompanying drawings. A brief description of those drawings now follows.

FIG. 1 is a cross sectional view of an example spool valve known in the art.

FIG. 2 is a cross sectional view of a spool valve, according to an example embodiment of the invention.

FIG. 3 is a cross-sectional view of a spool valve, according to another example embodiment of the invention with a reduced internal diameter of a spool thereof.

FIG. 4 is a cross-sectional view of a spool valve, according to another example embodiment of the invention with a chamfered retention pocket.

FIG. 5 is a cross sectional view of a spool valve, according to a further example embodiment of the invention with a tapered spring.

FIG. 6 is a perspective cross sectional view of a camshaft phasing assembly including the spool valve of FIG. 2.

FIG. 7 is a cross sectional view of the camshaft phasing assembly of FIG. 6 taken along line A-A of FIG. 6.

Identically labeled elements appearing in different one of the figures refer to the same elements but may not be referenced in the description for all figures. The exemplification set out herein illustrates at least one example embodiment of the invention, in at least one form, and such exemplification is not to be construed as limiting the scope of the invention in any manner.

### DETAILED DESCRIPTION

It is well known in the art that for obtaining the most effective and fuel saving operation possible of an internal combustion engine, it can be useful to change cam lobe (lift event) timing to crank shaft timing while the engine is operating. Camshaft phasers replace sprockets or pulleys on camshafts. The cam lobe angular position, or phase relationship, is controlled by the internal vane mechanism of the cam phaser. These vanes are moved circumferentially around the cam phaser by the use of oil supplied to either side of the vane, advancing or retarding the camshaft position. Commands from the engine control module (or central engine computer) adjust the position of a spool in the oil control valve, in turn, controlling the oil flow. According to an example aspect of the invention, this function can be achieved in a small space, utilizing less material and reducing mass of the system with improved ease of assembly as compared to known systems by incorporating a spring retention pocket in the spool, and removing the existing recess in the spool valve housing.

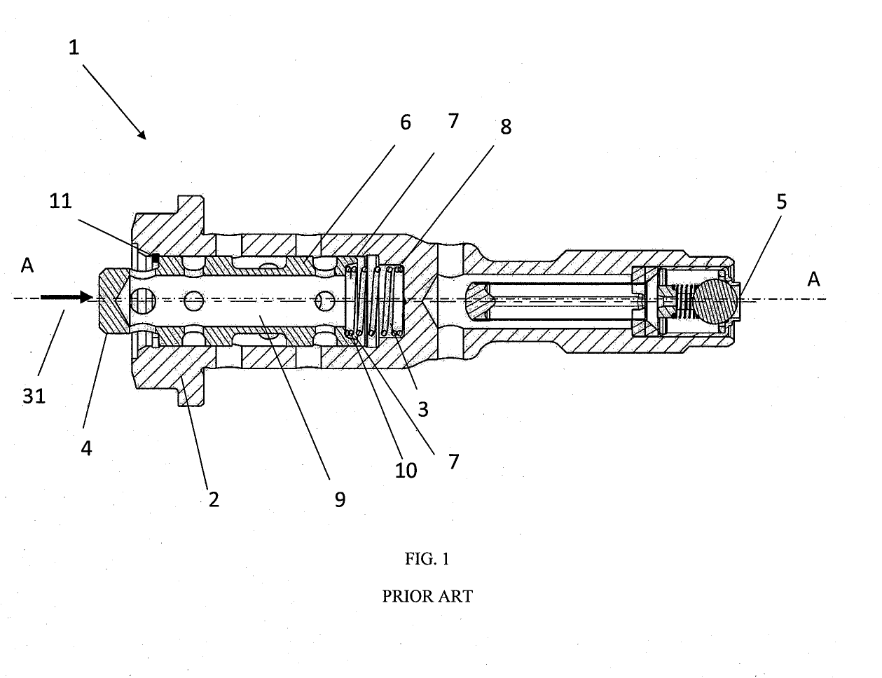

FIG. 1 shows a cross section of a known embodiment of a spool valve 1, shown with an integrated check valve as described in U.S. Pat. No. 7,000,580 and an integrated clamping screw as described in U.S. Pat. No. 6,363,896. Spool valve 1 comprises spool valve housing 2, spring 3, spool 4, one or more check valves 5, one or more annular ridges 6, spool housing spring retention recess 8, spool inner diameter oil channel 9, spool spring groove 10 and retention clip 11. In this valve 1, spring 3 is provided in housing spring retention recess 8 prior to assembling spool 4 into spool valve housing 2. A limitation of such a construction can occur when spring 3 is improperly seated and comes into contact with contact chamfer 7 of spool 4, causing pinching or other functional or assembly problems of spring 3. External force 31 is shown applied in the indicated direction in order to displace spool 4 within housing 2 and effect the valve operation.

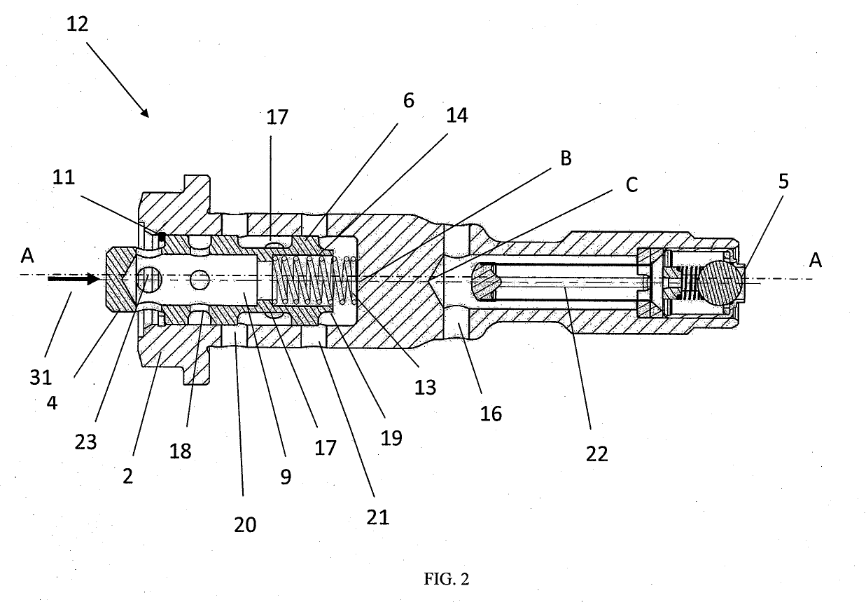

FIG. 2 is a cross section of a spool valve 12 constructed according to an example embodiment of the invention. Spool valve 12 comprises spool valve housing 2, spring 13 with a reduced diameter relative to spring 3, one or more check valves 5, one or more annular ridges 6, spool spring retention pocket 14 formed in spool 4, spool spring retention pocket channel 15, and spool inner diameter oil channel 9. Although three annular ridges 6, and one check valve 5 are shown, any number of annular ridges 6, and check valves 5 are anticipated by the invention. Consecutive annular ridges 6 form spaces between them, allowing passage of oil between the ridges 6, while ridges 6 maintain contact with the inside diameter wall of housing 2 to prevent oil flow between the ridges 6 and housing 2. Also shown are retention clip 11, oil access path 16, oil ports 17, oil exhaust A 18, oil exhaust B 19, oil port A 20, and oil port B 21. In this example embodiment, spring 13 may be inserted into spring retention pocket 14 prior to both being assembled into housing 2, eliminating or substantially reducing the possibility of improper placement of spring 13 within valve 12 upon assembly. In addition, further reduction in mass and size of spool valve 12 may be accomplished by reducing the size of spring 13 and spool 4 and eliminating material from spool housing 2 between points B and C.

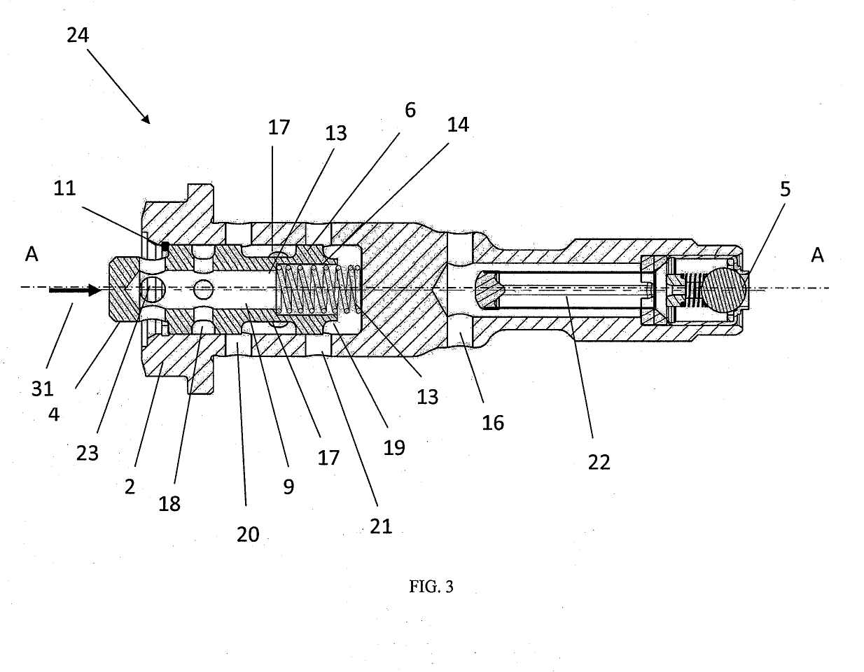

FIG. 3 shows a cross section of a spool valve 24 according to another example embodiment of the invention. Valve 24 is similar to valve 12 of FIG. 2, except that the spool inner diameter oil channel 9 is reduced in diameter relative to that of valve 12 due to the non-inclusion in valve 24 of a transition diameter formed by spool spring retention pocket channel 15 of spool inner diameter oil channel 9 included in the valve 12 of FIG. 2. Similar to valve 12 of FIG. 2, spool valve 24 comprises spool valve housing 2, reduced diameter spring 13, one or more check valves 5, one or more annular ridges 6, spool spring retention pocket 14 formed in spool 4, and spool inner diameter oil channel 9. Although three annular ridges 6, and one check valve 5 are shown, any number of annular ridges 6, and check valves 5 are anticipated by the invention. Also shown are retention clip 11, oil access path 16, oil ports 17, oil exhaust A 18, oil exhaust B 19, oil port A 20, and oil port B 21. Reducing the diameter of oil channel 9 and not including channel 15 can be useful to ease machining of spool 4 and flow of hydraulic fluid through channel 9.

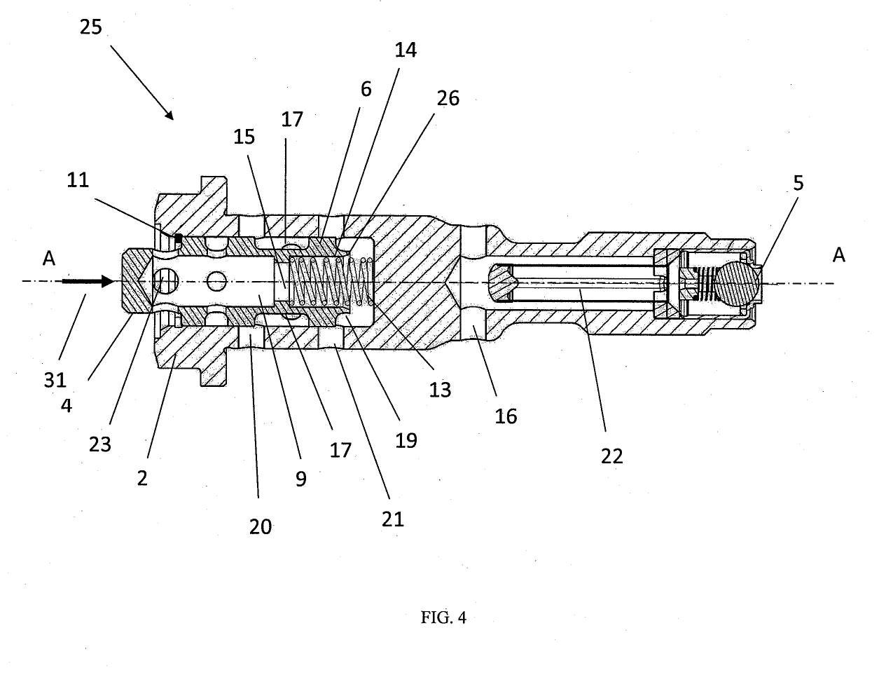

FIG. 4 shows a cross section of a spool valve 25 according to another example embodiment of the invention, wherein the valve 25 is like that of FIG. 2 but the spool spring retention pocket 14 includes a lead-in chamfer 26 to guide spring 13 into pocket 14 and prevent spring 13 from becoming deformed by improperly contacting a sharp corner during insertion of spring 13 into pocket 14. Instead of or in conjunction with lead-in chamfer 26, the edge portion of spool 4 at the location of chamfer 26 may be widened or otherwise displaced apart to allow for a wider opening to receive spring 13.

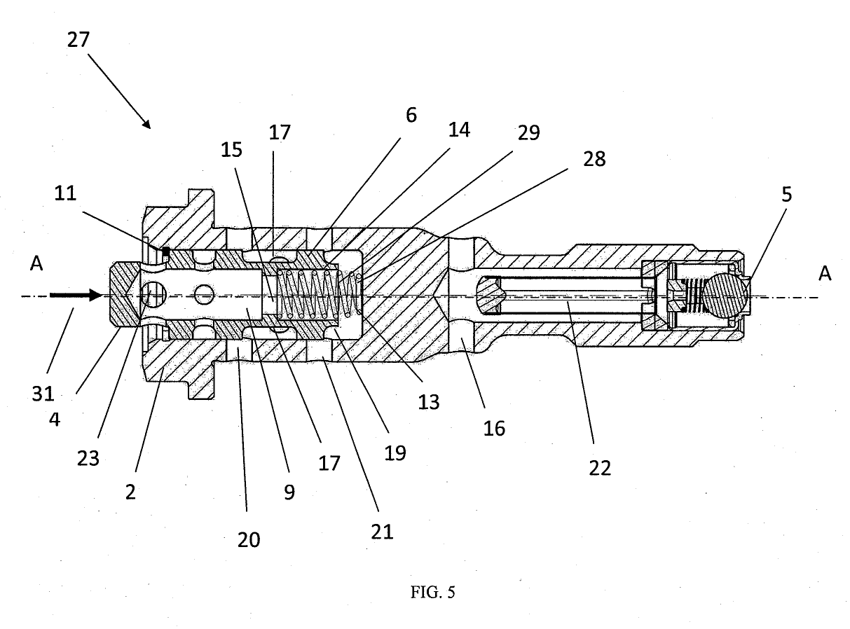

FIG. 5 shows a spool valve 27 according to another example embodiment of the invention, wherein the valve 27 is like that of FIG. 2, except that reduced diameter spring 13 is replaced with another spring 29 that includes a tapered portion 28 where it contacts the spool valve housing 2. Although the spring 29 has a tapered portion 28 in this example embodiment, variation of the spring 29 diameter in other manners besides that depicted, is also anticipated by this invention.

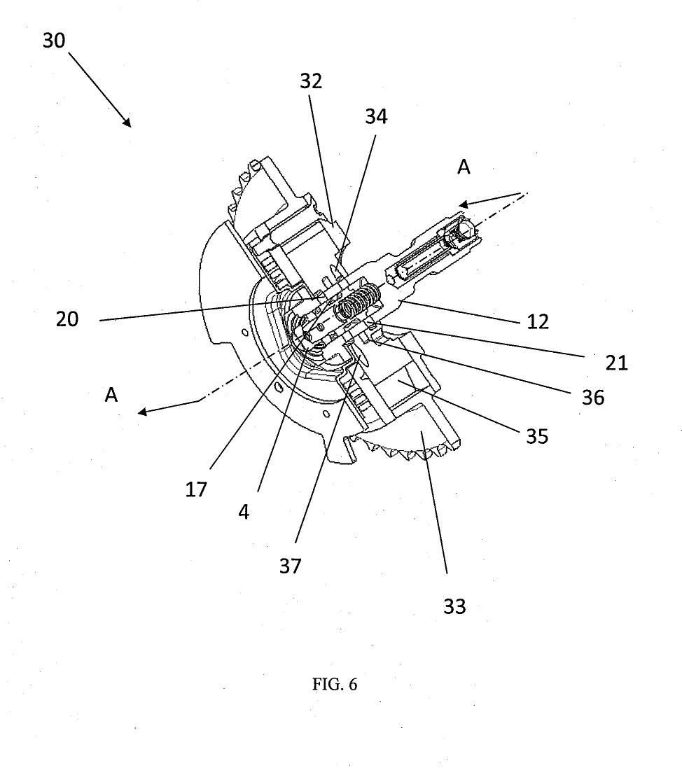

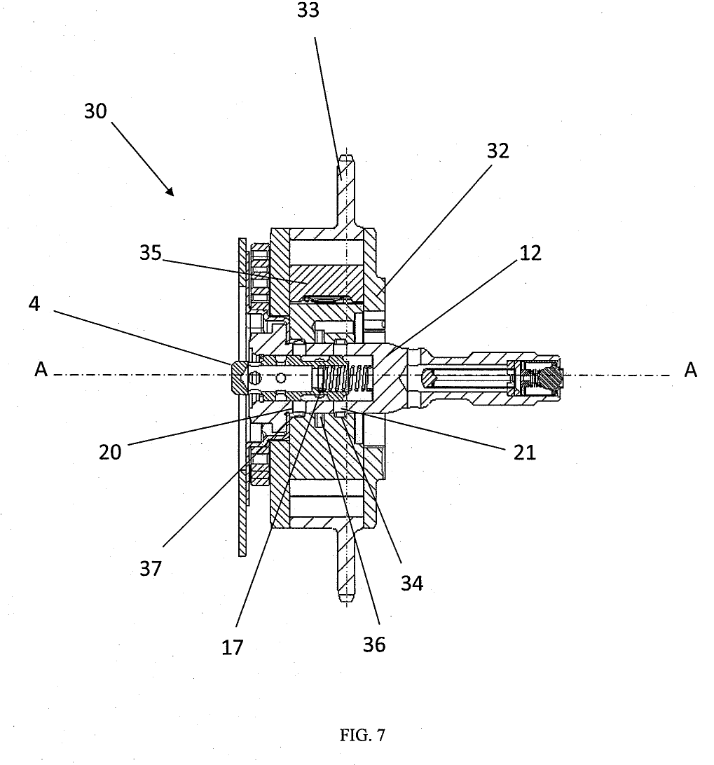

FIG. 6 shows a perspective cross sectional view of an example embodiment of a camshaft phasing assembly 30, including spool valve 12 and FIG. 7 shows the camshaft phasing assembly 30 of FIG. 6, taken along line A-A of FIG. 6. In this example embodiment, hydraulic fluid enters the spool 4 of spool valve 12 through oil access port 36 in camshaft phaser 32 and oil port 17 in spool valve 12. Spool 4's position within housing 2 controls hydraulic fluid entering and exiting associated cam phaser 32. Cam phaser 32 is controlled by hydraulic fluid entering and exiting one side of camshaft phaser vane 35 of camshaft phaser 32 through spool valve oil port B 21 in spool valve 12 and camshaft phaser oil port B 34 in phaser 32. Similarly, oil enters and exits the other side of vane 35 through spool valve oil port A 20 in spool valve 12 and camshaft phaser oil port A 37 within camshaft phaser 32. By controlling fluid flow to one side of vane 35 or the other in such a manner, vane 35 is moved circumferentially around camshaft phaser 32, phasing the associated camshaft (not shown) on the end of which camshaft phasing assembly 30 is assembled. Also shown is sprocket 33 which is driven by a chain (not shown) generally from the engine crankshaft (not shown). Although a sprocket 33 is shown, any other form of driving mechanism also can be employed.

According to an example aspect of the invention, for each of the embodiments depicted in FIGS. 2-5, the spring 13 (FIGS. 2-4) or spring 29 (FIG. 5) can be assembled into spool retention pocket 14, both of which can be inserted into spool 4, which then can be collectively inserted into housing 2. Then retention clip 11 can be inserted in order to retain those components in the housing 2 in the manner shown. In addition, this can be done with a smaller mass and volume of material in the example spool valves, 12 (FIG. 2), 24 (FIG. 3), 25 (FIGS. 4), and 27 (FIG. 5), as described above.

The manner in which hydraulic fluid is supplied for a camshaft phasing operation according to an example aspect of the invention will now be described with reference to FIGS. 2-7. Oil at typical system pressure is supplied through check valve 5. This oil is filtered through oil supply passage 22, entering external supply passages in cam phaser 32 through oil access path 16. Oil re-enters the spool valve through camshaft phaser oil access port 36 and then through a plurality of oil ports 17, filling a central annular space of spool 4 formed by annular ridges 6. In the position shown, oil from spool valve 12 enters one side of a vane 35 of the cam phaser 32 through oil port A 20, and oil exits the opposite side of vane 35 of the cam phaser 32 through oil port B 21. The oil from port B 21 enters oil exhaust B 19, and flows through spring retention pocket 14, channel 15 (in the case of FIGS. 2, 4 and 5), spool inner diameter oil channel 9, and back into the engine oil system at oil exhaust port 23. When the engine control module (ECM, not shown) supplies a signal to an external actuator (not shown) to provide a force 31 acting on spool 4, spool 4 is displaced in such a manner that oil port A 20 aligns with oil exhaust A 18, allowing oil from the one side of vane 35 of cam phaser 32 to exit from cam phaser 32, and oil from port 17 is supplied to the opposite side of the cam phaser vane 35 through oil port B 21. Oil exiting from cam phaser 32 through oil exhaust A 18, flows into oil channel 9 and exits back into the engine system through oil exhaust 23.

When force 31 is removed, spring 13 exerts a force on spool 4 displacing spool 4 in such a manner that oil port A 20 aligns with the central annular space formed by ridges 6 on spool 4, allowing communication with oil port 17 and providing oil to one side of vane 35. In turn, oil exhaust B 19 aligns with oil port B 21, allowing oil from the other side of vane 35 of cam phaser 32 to exit from cam phaser 32 through oil exhaust B 19 and into channel 9. Oil from channel 9 exits camshaft phasing assembly 30 back into the engine system through oil exhaust 23.

A result of the above method is to actively change cam lobe (lift event) timing to crank shaft timing while the engine is operating, thus improving efficiency and performance of an internal combustion engine.

In the foregoing description, example aspects of the invention are described with reference to specific example embodiments thereof. The specification and drawings are accordingly to be regarded in an illustrative rather than in a restrictive sense. It will, however, be evident that various modifications and changes may be made thereto, without departing from the broader spirit and scope of the present invention.

In addition, it should be understood that the figures illustrated in the attachments, which highlight the functionality and advantages of the present invention, are presented for example purposes only. The architecture or construction of example aspects of the present invention is sufficiently flexible and configurable, such that it may be utilized (and navigated) in ways other than that shown in the accompanying figures.

Although example aspects of this invention have been described in certain specific embodiments, many additional modifications and variations would be apparent to those skilled in the art. It is therefore to be understood that this invention may be practiced otherwise than as specifically described. Thus, the present example embodiments of the invention should be considered in all respects as illustrative and not restrictive.

What is claimed is:

1. A spool valve for a camshaft phaser, comprising:
a spool valve housing;
an axially displaceable, perforated, hollow spool movable within said housing and having a retention pocket;
at least one spring disposed at least partly in the retention pocket in said spool, and in contact with said housing; and
at least one check valve to allow selective ingress of a hydraulic fluid or prevent egress of hydraulic fluid through said valve.

2. The spool valve of claim 1, wherein said spring contacts an inner surface of said housing, disposed opposite to the retention pocket.

3. The spool valve of claim 2, wherein said inner surface of said housing is a flat surface across the inner diameter of said housing.

4. The spool valve of claim 1, wherein said retention pocket retains said spring in position in said valve.

5. The spool valve of claim 1, wherein said retention pocket has a lead-in chamfer.

6. The spool valve of claim 1, wherein a diameter of said spring varies in size along a length of said spring.

7. The spool valve of claim 1, wherein an inner facing circumferential surface of said hollow spool varies in size along a length thereof.

8. The spool valve of claim 1, wherein said hollow spool includes a plurality of access ports along its length, forming perforations.

9. The spool valve of claim 1, wherein said hollow spool includes a plurality of annular ridges, forming annular spaces between them.

10. A method of operating a spool valve, the method comprising:
exerting force to a spool of the spool valve, the spool valve comprising a spool housing, the hollow spool, and a spring, the hollow spool including a retention pocket, and the hollow spool and spring being disposed at least partly in a bore of the spool housing; and
controllably displacing the hollow spool to selectively provide one or more oil passageways through the spool valve in response to the force being exerted to the spool.

11. The method of claim 9, wherein the displacing includes displacing the hollow spool with respect to the housing to selectively align at least one annular space in the spool with at least one port in the housing.

12. The method of claim 10, wherein the selectively aligning enables oil to be propagated through at least one of the port and space.

13. The method of claim 9, wherein the selectively aligning enables at least one of oil egress through the at least one annular space and exhausting of oil through the at least one port in the spool.

14. The method of claim 9, wherein the spring is disposed at least partly in the retention pocket of the spool, and biases the spool against the force.

15. The method of claim 11, wherein the propagated oil operates a camshaft phasing system.

16. The method of claim 9, wherein the retention pocket includes a chamfer or displaced material.

17. The method of claim 9, wherein a diameter of the spring varies in size along a length of the spring.
